(19) United States
(12) Patent Application Publication
(10) Pub. No.: US 2016/0376098 A1
(43) Pub. Date: Dec. 29, 2016

(54) SILO SYSTEM

(71) Applicant: Lake Oil Field Services, Inc., San Antonio, TX (US)

(72) Inventors: Douglas S. Cain, San Antonio, TX (US); Jose Antonio Medina, Torreon (MX)

(73) Assignee: Lake Oil Field Services, Inc., San Antonio, TX (US)

(21) Appl. No.: 14/750,858

(22) Filed: Jun. 25, 2015

(51) Int. Cl. B65D 88/72; B65D 88/08; B65G 65/40

(52) U.S. Cl. CPC B65D 88/72; B65G 65/40; B65D 88/08

(57) ABSTRACT

A silo system is described that can store and dispense material. The silo system can include a silo cap that can include features for assisting with dispensing the material efficiently and effectively. For example, the silo cap can include a discharge port positioned at an apex of the silo cap and one or more aeration ports positioned proximate the discharge port.

### TECHNICAL FIELD

The subject matter described herein relates to a silo cap that is configured to assist with efficiently and effectively dispensing material from a silo.

### BACKGROUND

A silo can have a variety of uses, such as for storing materials in bulk. For example, silos can be used for storing grain, coal, cement, and food products. Some silos can also assist with dispensing their stored materials. Dispensing materials from some silos can be time consuming and the amount of material waste can be significant. For example, material can become trapped in the silo such that it is unable to be dispensed, thus wasting the trapped material.

### SUMMARY

Aspects of the current subject matter include a silo cap that is configured to assist with efficiently and effectively dispensing material from a silo. In one aspect, a method of the current subject matter includes activating an aerator that is in fluid communication with at least one aeration port located along a silo cap. The silo cap can be secured to a silo body thereby forming a storage area contained within the silo cap and the silo body, and the silo cap can have a tapered shape and positioned in a concave up configuration. The method can further include allowing flowing air from the aerator to flow through the aeration port and into the storage area, and the flowing air can cause a material contained within the storage area to move about the storage area. The method can further include opening a discharge port proximate to an apex of the silo cap, and the discharge port can be configured to allow the material to exit the storage area when the discharge port is open. In addition, the method can include allowing the material to exit the storage area through the discharge port.

In another aspect of the current subject matter, a silo system can include a silo body having a sidewall that extends between a first silo end and a second silo end, with the second silo end comprising an opening. The silo system can include a silo cap and can be positioned in a concave up configuration, as well as including a tapered sidewall extending between a first cap end and a second cap end. The second cap end can be configured to secure to the second silo end thereby forming a storage area defined by the silo cap and the silo body, and the storage area can be configured to contain a material. The tapered silo cap can further include an aeration port that is configured to allow flowing air from an aerator to flow into the storage area for moving the material about the storage area and a discharge port proximate to an apex of the silo cap and is configured to allow the material to exit the storage area when in an open configuration. The silo system can further include a manifold having an aeration line that is configured to extend between the aerator and the aeration port and a discharge line that extends a distance from the discharge port.

In some variations one or more of the following features can optionally be included in any feasible combination. The tapered shape of the silo cap can include at least one of a conical shape, a pyramidal shape, a domed shape, and a tetrahedral shape. The silo body can include a sidewall that extends between a first silo end and a second silo end, and the second silo end can include an opening and configured to allow the silo cap to secure to the silo body. The silo cap can include a tapered sidewall extending between a first cap end and a second cap end, and the second cap end can be configured to secure to the second silo end with the first cap end including the discharge port. The apex can be centrally located along a centerline of the silo cap. The at least one aeration port can include a plurality of aeration ports disposed around the discharge port. The method can further include an aeration line extending between one or more of the at least one aeration ports and the aerator, and a discharge line extending from the discharge port. The silo cap can include a funnel feature that assists with directing the material contained in the storage area to the discharge port.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a side view illustrating an implementation of a silo system including a silo cap secured to an adaptable silo body;

FIG. 2A shows a side view of another implementation of the silo system, including a silo cap having four aeration ports disposed around a discharge port, with aeration lines extending from the aeration ports and a discharge line extending from the discharge port.

FIG. 2B shows a perspective view of a manifold of the silo system of FIG. 2; and

FIG. 3 shows a process flow diagram illustrating aspects of a method having one or more features consistent with implementations of the current subject matter.

When practical, similar reference numbers denote similar structures, features, or elements.

### DETAILED DESCRIPTION

The current subject matter is directed to a silo system that can store and dispense material. The silo system can include a silo cap that can include features for assisting with dispensing the material efficiently and effectively. For example, the silo cap described herein can assist with dispensing material from the silo system such that the amount of wasted material (e.g., material that gets trapped or left behind in the silo system) can be reduced compared to other silos. In some implementations of the silo cap, for example, the amount of wasted material can be reduced by approximately 75%. In addition, the silo cap described herein can assist with dispensing material from the silo system more quickly than other silos. For example, the silo cap can save approximately 30% to approximately 70% in the amount of time it takes to dispense material from the silo system. As such, the silo system described herein, including the silo cap, can reduce resources required to deliver a material to a location, such as by reducing the amount of time required to dispense the material and reduce the amount of wasted material.

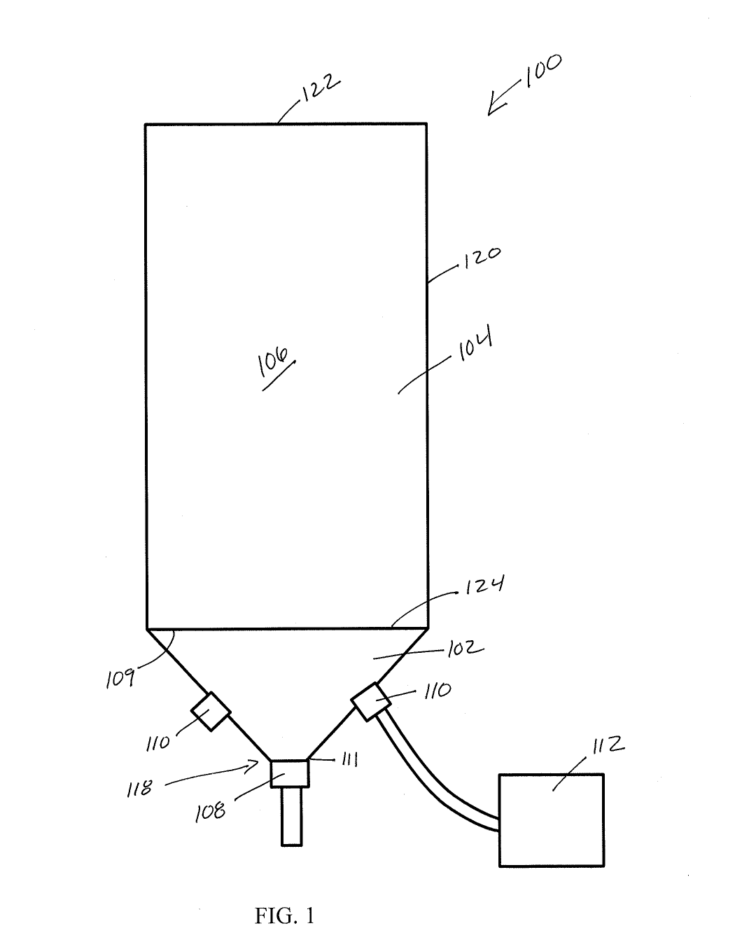

FIG. 1 illustrates an implementation of a silo system 100 that includes a silo cap 102 coupled to an adaptable silo body 104. The silo cap 102 coupled to the silo body 104 can form a storage area 106 therebetween. The storage area 106 can be configured to store one or more of a variety of materials (e.g., cement, grain, etc.). The silo cap 102 can include a discharge port 108 that is configured to allow the material contained within the storage area 106 to dispense from the storage area 106, such as when the discharge port 108 is open (i.e., in an open configuration). When the discharge port 108 is closed, or in a closed configuration, the discharge port 108 can assist with storing the material within the storage area 106. Although the silo system 100 is described herein as having a silo cap 102 coupled to an adaptable silo body 104, the silo system 100 can include a unified silo body that includes any of the features described herein associated with either the silo cap 102 or silo body 104.

As shown in FIG. 1, the silo cap 102 can have a tapered shape and be positioned in a concave up configuration. For example, an inner portion of the silo cap 102 can include a funnel feature that assists with funneling or directing the material toward the discharge port 108. In the concave up configuration, the funnel feature can be positioned such that the material is allowed to funnel in a substantially downward direction and dispense out the discharge port 108 when the discharge port 108 is in the open configuration. The silo cap 102 can have one or more of a variety of tapered shapes, such as conical, pyramidal, domed, or tetrahedral. However, the silo cap 102 can have any shape without departing from the scope of this disclosure.

In some implementations, the silo cap can include a tapered sidewall that extends between a first cap end 109 and a second cap end 111. The first cap end 109 can be open and include features that assist with securing the silo cap 102 to the silo body 104 (e.g., a flange, attachment holes, clamps, etc.). The second cap end 111 can include the discharge port 108.

The silo cap 102 can also include one or more aeration ports 110. Each aeration port 110 can allow flowing air from an aerator 112 to flow through the aeration port 110 and into the storage area 106. Once in the storage area 106, the flowing air can force at least some of the material contained within the storage area 106 to move about the storage area 106. For example, the flowing air can force the material to move about such that the material becomes less dense. The material can become less dense, for example, as a result of the flowing air fluffing or spreading out the material within the storage area 106. This less dense material can be more easily dispensed out through the discharge port 108, which can allow the material to be dispensed more quickly. In addition, by forcing the material to move about the storage area 106, the flowing air can assist with reducing the amount of material that gets trapped or left behind within the storage area 106, thereby reducing material waste.

The discharge port 108 can be positioned such that it is located at a distal most end of the silo cap 102. For example, the discharge port 108 can be positioned at an apex 118 of the tapered shape of the silo cap 102, as shown in FIG. 1. This can allow the material to more easily dispense from the discharge port 108 and minimize material left behind in the storage area 106 (i.e., minimize material waste). The apex 118 can be centrally positioned relative to either the silo cap 102 or silo body 104. For example, the discharge port 108 can be centrally positioned along a centerline of the silo cap 102. However, the apex 118 can be positioned in any one of a variety of positions, such as off-centered from either the silo cap 102 or silo body 104.

In some implementations, the adaptable silo body 104 can include a sidewall 120 that extends between a first silo end 122 and a second silo end 124. The second silo end 124 can include an opening that can communicate with the discharge port 108, such as when the silo body 104 and silo cap 102 are coupled together. The storage area 108 can be formed between the coupled silo body 104 and silo cap 102 and can store a material that is dispensable through the discharge port 108. The first silo end 122 can be substantially closed in order to assist with containing the material within the storage area 106.

The second silo end 124 can include a body attachment feature that assists with coupling the silo cap 102 to the silo body 104. In addition, the first cap end 109 of the silo cap 102 can include a cap attachment feature that assists with coupling the silo cap 102 to the silo body 104. The silo cap 102 can be coupled to the silo body 104 in any number of a variety of ways, such as by bolting or welding the silo cap 102 to the silo body 104. As discussed above, the silo cap 102 and silo body 104 can be unified such that there is only a single unified silo body, thus not requiring the silo cap 102 to be coupled to a silo body 104. However, in some implementations, the silo cap 102 can be configured to be coupled to a variety of adaptable silo bodies. The silo cap 102 can also be releasably coupled to a silo body 104, which can allow the silo cap 102 to be removed from the silo body 104, such as for cleaning or repair.

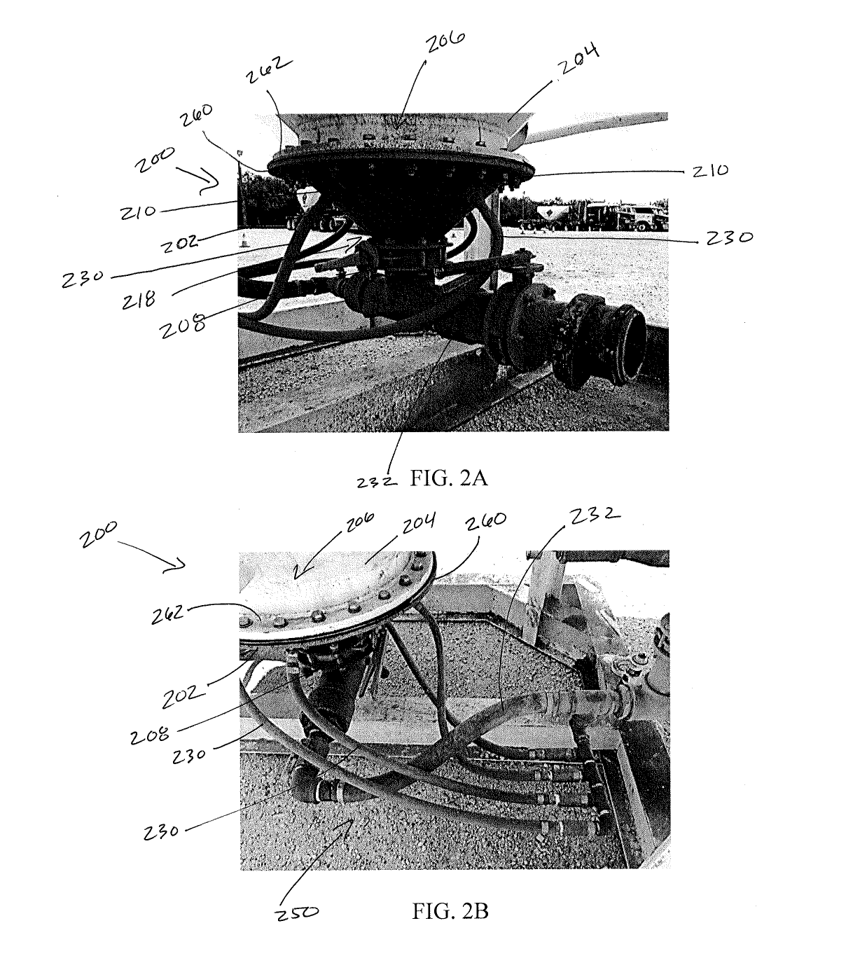

FIGS. 2A-2B show another implementation of a silo system 200 including a silo cap 202 with a centrally located discharge port 208. As shown in FIG. 2A, the silo cap 202 can include a tapered shape, with the discharge port 208 located at the apex 218 of the tapered shape. The silo cap 202 can further include four aeration ports 210 disposed around the discharge port 208. Aeration lines 230 can extend between the aeration ports 210 and an aerator. The aeration lines 230 can provide a fluid pathway for the flowing air to travel between the aerator and the aeration ports 210, such as when the aerator is activated or turned on. A discharge line 232 can extend from the discharge port 208 and assist with providing a guided passageway for the material to dispense from the storage area 206 to a location.

The silo system 200 can also include a manifold 250, as shown in FIG. 2B. The manifold 250 can include one or more aeration lines 230 and one or more discharge lines 232, any of which can be independent from or in fluid communication with another aeration line 230 or discharge line 232. In some implementations, the manifold 250 can also include additional fluid lines, which can assist with dispensing the material from the storage area 206.

As shown in FIGS. 2A and 2B, the silo cap 202 can include a first flange 260 that can be coupled to a second flange 262 of the silo body 204. The first flange 260 and second flange 262 can be coupled together, for example, by extending and securing bolts through the first and second flanges 260, 262. However, the silo cap 202 and silo body 204 can include any number of a variety of features for assisting with coupling the silo cap 202 to the silo body 204 without departing from the scope of this disclosure. In addition, the silo cap 202 can be coupled to the silo body 204 in any number of a variety of ways without departing from the scope of this disclosure.

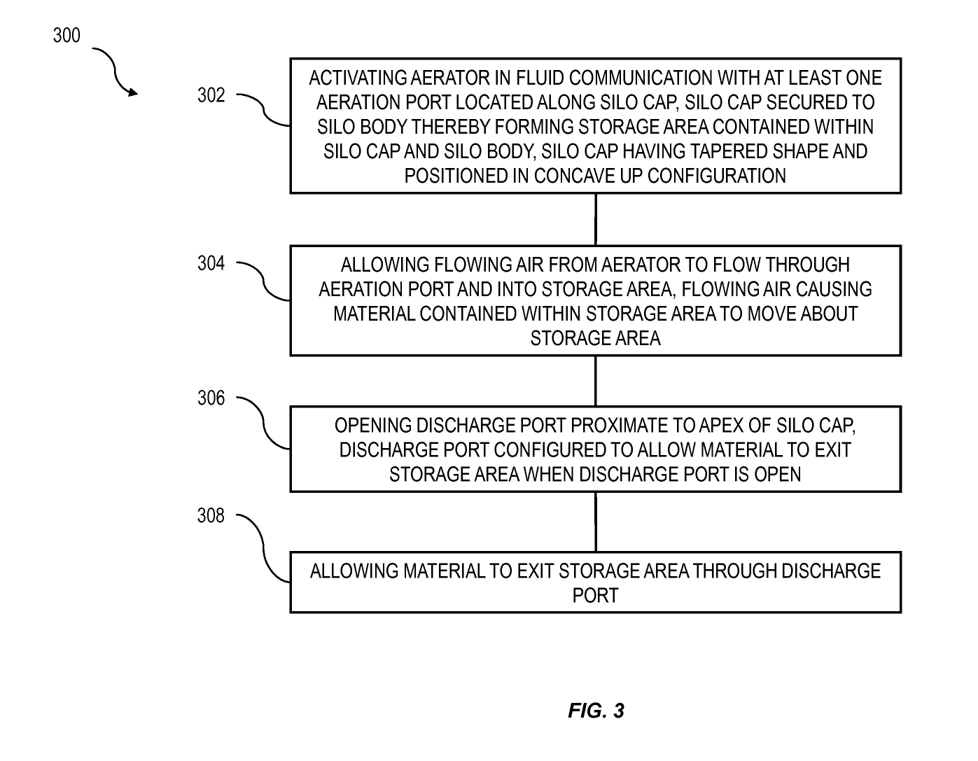

FIG. 3 shows a process flow chart 300 illustrating features of a method consistent with one or more implementations of the current subject matter. It will be understood that other implementations may include or exclude certain features. At 302, an aerator can be activated that is in fluid communication with at least one aeration port located along a silo cap. The silo cap can be secured to a silo body thereby forming a storage area contained within the silo cap and the silo body. The silo cap can have a tapered shape and positioned in a concave up configuration. At 304, flowing air from the aerator can be allowed to flow through the aeration port and into the storage area. The flowing air can cause a material contained within the storage area to move about the storage area. At 306, a discharge port proximate to an apex of the silo cap can be opened. The discharge port can be configured to allow the material to exit the storage area when the discharge port is open. At 308, the material is allowed to exit the storage area through the discharge port.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. A method comprising:
activating an aerator that is in fluid communication with at least one aeration port located along a silo cap, the silo cap secured to a silo body thereby forming a storage area contained within the silo cap and the silo body, the silo cap having a tapered shape and positioned in a concave up configuration;
allowing flowing air from the aerator to flow through the aeration port and into the storage area, the flowing air causing a material contained within the storage area to move about the storage area;
opening a discharge port proximate to an apex of the silo cap, the discharge port configured to allow the material to exit the storage area when the discharge port is open; and
allowing the material to exit the storage area through the discharge port.

2. The method of claim 1, wherein the tapered shape comprises at least one of a conical shape, a pyramidal shape, a domed shape, and a tetrahedral shape.

3. The method of claim 1, wherein the silo body comprises a sidewall that extends between a first silo end and a second silo end, the second silo end comprising an opening and being configured allow the silo cap to secure to the silo body.

4. The method of claim 3, wherein the silo cap comprises a tapered sidewall extending between a first cap end and a second cap end, the second cap end being configured to secure to the second silo end and the first cap end including the discharge port.

5. The method of claim 1, wherein the apex is centrally located along a centerline of the silo cap.

6. The method of claim 1, wherein the at least one aeration port comprises a plurality of aeration ports disposed around the discharge port.

7. The method of claim 1, further comprising an aeration line extending between one or more of the at least one aeration ports and the aerator.

8. The method of claim 1, further comprising a discharge line extending from the discharge port.

9. The method of claim 1, wherein the silo cap includes a funnel feature that assists with directing the material contained in the storage area to the discharge port.

10. A silo system comprising:
a silo body having a sidewall that extends between a first silo end and a second silo end, the second silo end comprising an opening; and
a silo cap and positioned in a concave up configuration and comprising a tapered sidewall extending between a first cap end and a second cap end, the second cap end being configured to secure to the second silo end thereby forming a storage area defined by the silo cap and the silo body, the storage area configured to contain a material, the tapered silo cap further comprising
an aeration port that is configured to allow flowing air from an aerator to flow into the storage area for moving the material about the storage area; and
a discharge port proximate to an apex of the silo cap and configured to allow the material to exit the storage area when in an open configuration;
a manifold having an aeration line that is configured to extend between the aerator and the aeration port and a discharge line that extends a distance from the discharge port.

11. The silo system of claim 10, wherein the tapered shape comprises at least one of a conical shape, a pyramidal shape, a domed shape, and a tetrahedral shape.

12. The silo system of claim 10, wherein the apex is centrally located along a centerline of the silo cap.

13. The silo system of claim 10, further comprising more than one aeration port disposed around the discharge port.

14. The silo system of claim 10, wherein the silo cap includes a funnel feature that assists with directing the material contained in the storage area to the discharge port.

15. A silo cap comprising:
a tapered sidewall extending between a first cap end and a second cap end, the second cap end being configured to secure to an end of an adaptable silo body to form a storage area defined by the silo cap and the adaptable silo body, the storage area being configured to contain a material;
an aeration port that is configured to allow air to flow into the storage area for moving the material about the storage area; and
a discharge port proximate to an apex of the silo cap and configured to allow the material to exit the storage area when in an open configuration.

16. The silo cap of claim 15, wherein the tapered shape comprises at least one of a conical shape, a pyramidal shape, a domed shape, and a tetrahedral shape.

17. The silo cap of claim 15, wherein the apex is centrally located along a centerline of the silo cap.

18. The silo cap of claim 15, further comprising more than one aeration port disposed around the discharge port.

19. The silo cap of claim 15, further comprising at least one of an aeration line extending between the aeration port and an aerator and a discharge line extending from the discharge port.

20. The silo cap of claim 15, wherein the silo cap includes a funnel feature that assists in directing the material contained in the storage area to the discharge port.
